(19) United States
(12) Patent Application Publication
(10) Pub. No.: US 2018/0134939 A1
(43) Pub. Date: May 17, 2018

(54) METHOD OF USING CROSSLINKED WELL TREATMENT AGENTS FOR SLOW RELEASE INTO WELL

(71) Applicant: Baker Hughes, a GE company, LLC, Houston, TX (US)

(72) Inventors: D.V. Satyanarayana Gupta, The Woodlands, TX (US); Dong Shen, Houston, TX (US)

(21) Appl. No.: 15/593,215

(22) Filed: May 11, 2017

Related U.S. Application Data
(63) Continuation-in-part of application No. 14/690,809, filed on Apr. 20, 2015.
Application No. 14/690,809 is a continuation-in-part of application No. 12/839,047, filed on Jul. 19, 2010, now Pat. No. 9,010,430.
Application No. 12/839,047 is a continuation-in-part of application No. 13/094,186, filed on Apr. 26, 2011, now Pat. No. 9,029,300.
Application No. 13/094,186 is a continuation-in-part of application No. 13/678,431, filed on Nov. 15, 2012, now Pat. No. 9,874,080.
Application No. 13/678,431 is a continuation-in-part of application No. 15/436,464, filed on Feb. 17, 2017.
Application No. 15/436,464 is a continuation-in-part of application No. 14/704,739, filed on May 5, 2015, now Pat. No. 9,574,130.
Application No. 14/704,739 is a division of application No. 13/094,186, filed on Apr. 26, 2011, now Pat. No. 9,029,300.
(60) Provisional application No. 62/028,151, filed on Jul. 23, 2014.
(60) Provisional application No. 61/562,887, filed on Nov. 22, 2011.

(51) Int. Cl. C09K 8/03; C09K 8/524; C09K 8/528; C09K 8/54; E21B 37/06

(52) U.S. Cl. CPC C09K 8/03; C09K 8/524; C09K 2208/32; C09K 8/54; E21B 37/06; C09K 8/528

(57) ABSTRACT

A shaped compressed pellet formed from a crosslinked well treatment agent may be introduced into a well. Upon uncrosslinking, the well treatment agent may be used to prevent and/or control the formation of deposits in the well.

This application is a continuation-in-part application of U.S. patent application Ser. No. 14/690,809, filed on Apr. 20, 2015 which is a continuation-in-part application of U.S. patent application Ser. No. 12/839,047, filed on Jul. 19, 2010, now U.S. Pat. No. 9,010,430 and U.S. patent application Ser. No. 13/094,186, filed on Apr. 26, 2011, now U.S. Pat. No. 9,029,300. This application is also a continuation-in-part application of U.S. patent application Ser. No. 15/436,464, filed on Feb. 17, 2017, which is a continuation-in-part of U.S. patent application Ser. No. 14/704,739, filed on May 5, 2015, which is a divisional application of U.S. patent application Ser. No. 13/094,186, filed on Apr. 26, 2011, now U.S. Pat. No. 9,029,300, issued on May 12, 2015, all of which are herein incorporated by reference.

### FIELD OF THE DISCLOSURE

The disclosure relates to shaped compressed pellets formed from a crosslinked well treatment agent and methods of using the same in the slow release of well treatment agents into a well. The crosslinked well treatment agents have hydrolyzable bonds. Upon hydrolysis of the hydrolyzable bonds, uncrosslinking causes the well treatment agent to be released from the shaped compressed pellet and into the well. The crosslinked well treatment agent may further be introduced into the well in a screen assembly. Upon its release, the well treatment agent passes from the screen into the well containing produced fluids.

### BACKGROUND OF THE DISCLOSURE

Fluids produced from wells typically contain a complex mixture of components including aliphatic hydrocarbons, aromatics, hetero-atomic molecules, anionic and cationic salts, acids, sands, silts and clays. The nature of these fluids, combined with the severe conditions of heat, pressure, and turbulence to which they are often subjected, are contributing factors to the formation and deposition of contaminants, such as scales, salts, paraffins, corrosion, bacteria and asphaltenes in oil and/or gas production wells and surface equipment.

Such contaminants typically restrict the movement of fluids in production piping and further potentially plug flow paths of fluids (including reservoir flow paths). For instance, common mineral scales such as calcium carbonate, calcium sulfate, or barium sulfate often precipitate from produced water and create blockages in flow paths in production tubulars. The formation and deposition of such contaminants typically decreases permeability of the subterranean formation, reduces well productivity, and, in some cases, completely blocks the tubing. In addition, such conditions shorten the lifetime of production equipment.

Well treatment agents are often used in production wells to prevent the deleterious effects caused by such deposits and precipitates. For instance, scaling in the formation (as well as in production lines downhole) is often controlled using scale inhibitors. Such agents may also be used after the well is killed.

Treatments to remove deposits and inhibit the formation of deposits include the use of various mechanical preventative techniques such as scrapers or reamers and chemical treatment agents such as inhibitors, acids and converters. While mechanical tools are effective when the tubular is at an approximate 180° to the point of entry (as gravity helps pull the treatment device into the well), they have limited effectiveness when the tubular being treated is deviated, as in a horizontal well or “S” shaped configuration. The flexibility of mechanical tools makes it difficult to push a long distance past a severe deviation or multiple deviations. Chemical prevention or remedial techniques can be effective if the treatment can be delivered reliably to the target location and in sufficient quantity to address the issues.

Chemical treatment agents may be delivered to deposits by the technique of “downhole squeezing” wherein a slug of a well treatment composition is injected into the annulus of the well, using a pre-flush, squeeze, and over flush treatment before the well can be returned to normal function. This technique requires large volumes of treatment and flush fluid in horizontal wells with a large area of perforated interval. Further treatments are typically required as the chemical residual is depleted, once again requiring large volumes of flush and treatment into the well. Such treatment methods are typically inefficient in horizontal wells because it is difficult to ensure the treatment is delivered to all the intended area. Further, the flush and chemical additives often require large pumps and holding tanks which can add significant costs to the application.

Solid chemical additives in the form of a slurry are further often used. This type of treatment is effective in vertical wells but requires a flush to aid in delivery of the treatment agent to the bottom of the well. In a deviated well such as a horizontal well or well with multiple deviations such as an “S” shaped completion, it is important that the slurry mass not be too heavy in order for the flush to be carried past the deviation. If the density of the slurry is too high, the slurry just settles beyond the deviation.

Capillary tubing lengths are frequently installed in wells to aid in delivery of a chemical treatment. This technique is effective in its intended function but is expensive and requires specialized equipment to install. Further, capillary tubing may not be able to extend to great depths if the deviation angle is severe or the piping extends far beyond the bend.

While solid additives have been added to the well during the completion stage, this technique has only been proven to be an effective delivery method in new wells when the opportunity to spot the chemical additive is available.

Other methods for introducing well treatment agents into production wells include forcing a liquid well treatment agent into a targeted zone of a formation by application of hydraulic pressure from the surface. In most cases, such treatments are performed at downhole injection pressures below that of the formation fracture pressure. Alternatively, the delivery method may consist of placing a solid well treatment agent into the producing formation in conjunction with a hydraulic fracturing operation. This method is often preferred because it puts the treatment agent in contact with the fluids contained in the formation before such fluids enter the wellbore where deleterious effects are commonly encountered.

A principal disadvantage of such methods is the difficulty in releasing the well treatment agent into the well over a sustained period. As a result, treatments must repeatedly be undertaken to ensure that the requisite level of treatment agent is continuously present in the well. Such treatments result in lost production revenue due to down time.

Accordingly, there exists a need for alternative treatment methods for introducing well treatment agents into oil and/or gas wells wherein the treatment agent may be released over a sustained period and especially where tubing is deviated or contains multiple deviations and/or where continuous attention of operators over prolonged periods is unnecessary.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

### SUMMARY OF THE DISCLOSURE

In an embodiment of the disclosure, a method of inhibiting or controlling the rate of release of a well treatment agent into a well is provided. In this embodiment, a shaped compressed pellet is introduced into the well, the shaped compressed pellet having a crosslinked well treatment agent. The crosslink bonds of the well treatment agent are hydrolyzable. Over time, the well treatment agent is released from the shaped compressed pellet upon hydrolysis of the hydrolyzable bonds.

In another embodiment, a method of inhibiting or controlling the rate of release of a scale inhibitor or corrosion inhibitor in a well is provided wherein a shaped compressed pellet having a crosslinked scale inhibitor or crosslinked corrosion inhibitor is placed into a receptacle. The crosslinks of the crosslinked scale inhibitor or crosslinked corrosion inhibitor are hydrolyzable bonds. The receptacle is then affixed to the bottom of a bottom hole electric submersible and the bottom hole electric submersible pump is then lowered into the well. The well treatment agent is then continuously released from the shaped compressed pellet and into the well upon hydrolysis of the hydrolysable bonds.

In another embodiment, a method of inhibiting or controlling the formation of scales or corrosion in a deviated well is provided. In this embodiment, a shaped compressed pellet having a crosslinked well treatment agent is introduced into a well. The crosslinked well treatment agent has hydrolysable bonds for crosslinks. The shaped compressed pellet is flowed over obstructions within the tubing and deviations in the well and into a targeted area in the well. The well treatment agent is then continuously released from the shaped compressed pellet into the targeted area upon hydrolysis of the hydrolysable bonds.

In another embodiment, a method of continuously releasing a well treatment agent into a killed well is provided. In this embodiment, a well treatment agent is placed into the interior of a screen assembly. The screen assembly is then introduced into the killed well. The well treatment agent is crosslinked by hydrolysable bonds. The mesh of the screen is sufficient to restrain flow of the crosslinked well treatment agent from the interior of the screen into reservoir fluids. The mesh of the screen is further sufficient for the well treatment agent to flow from the interior of the screen into reservoir fluids upon hydrolysis of the crosslinks. The crosslinked well treatment agent is uncrosslinked by hydrolysis of the hydrolysable bonds and the uncrosslinked well treatment agent is then released into the well.

In another embodiment of the disclosure, a method of continuously releasing a well treatment agent into a killed well is provided. In this method, a screen assembly containing a shaped compressed pellet within its interior is introduced into the killed well. The shaped compressed pellet contains a crosslinked well treatment agent. The mesh of the screen of the screen assembly is sufficient to restrain flow of the shaped compressed pellet from the interior of the screen assembly into reservoir fluids. The crosslinked well treatment agent is uncrosslinked by hydrolyzing crosslinked bonds. The uncrosslinked well treatment agent is then separated from the shaped compressed pellet and passes from the interior of the screen assembly into the killed well. The mesh of the screen of the screen assembly is sufficient for the uncrosslinked well treatment agent to flow from the interior of the screen into the killed well.

In another embodiment, a method of releasing a scale inhibitor or corrosion inhibitor into reservoir fluids produced in a well penetrating a subterranean formation is provided. In this method, a screen assembly is introduced into the well. The screen assembly has within its interior a well treatment agent crosslinked with hydrolysable bonds. The diameter of the opening in a screen of the screen assembly is smaller than the diameter of the crosslinked well treatment agent. The well treatment agent is released from the interior of the screen assembly upon hydrolysis of the hydrolysable bonds. The released well treatment agent then passes from the interior of the screen assembly into the reservoir fluids in the well. The diameter of the well treatment agent after hydrolysis of the hydrolysable bonds is less than the opening in the screen of the screen assembly.

In another embodiment, a method of releasing a scale inhibitor or corrosion inhibitor into reservoir fluids produced in a well penetrating a subterranean formation is provided. In this embodiment, a screen assembly having within its interior a shaped compressed pellet is introduced into the well. The shaped compressed pellet contains a well treatment agent crosslinked with hydrolysable bonds. The diameter of the opening in a screen of the screen assembly is less than the diameter of the shaped compressed pellet. The well treatment agent is then continuously released from the shaped compressed pellet into the interior of the screen assembly upon hydrolysis of the hydrolysable bonds. The released well treatment agent then passes from the interior of the screen assembly into the reservoir fluids in the well. The diameter of the released well treatment agent is less than the opening in the screen of the screen assembly.

In yet another embodiment, a method of continuously releasing over time a well treatment agent into a well or to a subterranean formation penetrated by the well is provided. In this method, a screen composed of multiple layers having openings is introduced into the well. A crosslinked well treatment agent comprising hydrolysable crosslink bonds is placed within the area defined by the multiple layers. The diameter of the openings of the multiple layers is smaller than the diameter of the crosslinked well treatment agent. After the well treatment agent is uncrosslinked by hydrolysis of the hydrolysable crosslink bonds, the well treatment agent is released into the well. The diameter of the at least one of the multiple layers is greater than the diameter of the uncrosslinked well treatment agent.

In another embodiment, a method of continuously releasing over time a well treatment agent into a well or to a subterranean formation penetrated by the well is provided. In this embodiment, a screen assembly having an enclosed screen is introduced into the well. Within the enclosed screen is a shaped compressed pellet having a well treatment agent crosslinked by hydrolysable bonds. The diameter of the openings of the enclosed screen are smaller than the diameter of the shaped compressed pellet. The well treatment agent is released from the shaped compressed pellet over time upon hydrolysis of the hydrolysable bonds. The released well treatment agent is then passed from the screen assembly into the well or the subterranean formation. The diameter of the openings of the enclosed screen are greater than the diameter of the released well treatment agent.

In another embodiment, a method of inhibiting or controlling the formation of scales and/or corrosion in a well is provided. In this embodiment, a shaped compressed pellet having a crosslinked scale inhibitor is introduced into a well. The crosslinked scale inhibitor produced by crosslinking a scale inhibitor having hydrolysable bonds with a crosslinking agent. The shaped compressed pellet is then permitted to flow into a targeted area in the well. The crosslinked scale inhibitor then uncrosslinks. The scale inhibitor is then released from the shaped compressed pellet into the targeted area by hydrolyzing the hydrolysable bonds. Further, the crosslinking agent upon uncrosslinking of the crosslinked scale inhibitor may act as a corrosion inhibitor.

In yet another embodiment, a method of inhibiting or controlling the formation of corrosion in a well is provided. In this embodiment, a shaped compressed pellet having a crosslinked corrosion inhibitor is introduced into the well. The crosslinked corrosion inhibitor has hydrolysable bonds and may be produced by crosslinking a crosslinkable monomer, oligomer, polymer, or a combination thereof with a crosslinking agent wherein the crosslinking agent is capable of inhibiting or controlling the formation of corrosion in the well. The shaped compressed pellet is flowed into a targeted area in the well. The crosslinked corrosion inhibitor is uncrosslinked and the crosslinking agent is continuously released into the targeted area by hydrolyzing the hydrolysable bonds.

In some embodiments, the hydrolyzable bonds forming the crosslinks of the well treatment agent are ester bonds, amide bonds, imide bonds, phosphoester bonds or a combination thereof.

In some embodiments, the well treatment agent is a scale inhibitor or corrosion inhibitor.

In another embodiment, the shaped compressed pellet may be either directly dropped into the well from the well head, directly dropped into the production tubing within the well or introduced in a receptacle suspended in the well.

In some embodiments, the referenced screen assembly is introduced into the well after the subterranean formation has been stimulated.

In some embodiments, the referenced screen assembly is situated in the well during shut-in of a stimulated well.

Accordingly, the present disclosure includes features and advantages for enabling the inhibition and are believed to enable it to inhibit and remove contaminants from a well.

### BRIEF DESCRIPTION OF THE DRAWINGS

FIG. 1 is a cross sectional view of a representative screen assembly for use in the method disclosed herein.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying FIGURE. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the embodiments and details disclosed herein without departing from such spirit and scope.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

The crosslinked well treatment agents defined herein are used in the treatment of gas or oil wells to inhibit the formation of contaminants, control the formation of contaminants or retard the release of contaminants into the well. The well treatment agent is preferably water soluble or soluble in aliphatic and aromatic hydrocarbons at downhole conditions. Such inhibitors are typically not readily soluble at room temperature.

The crosslinked well treatment agents and composites containing the same may be used in treatment operations near the wellbore in nature (affecting near wellbore regions) and may be directed toward improving wellbore productivity.

The crosslinked well treatment agent contains a crosslinked entity having hydrolyzable bonds. The crosslinked entity is the product of one or more crosslinking agents and one or more crosslinkable monomers, oligomers or polymers or a mixture of monomers, oligomers and/or polymers. The well treatment agent may either be the crosslinking agent(s) or the crosslinkable monomer(s), oligomer(s) or polymer(s). The well treatment agent is released by hydrolyzing the hydrolyzable bonds at in-situ conditions.

The crosslinked well treatment agents may also be used to control and/or prevent the undesired formation of salts, paraffins, gas hydrates, asphaltenes as well as corrosion in formations or on surface equipment. As such, the well treatment agent of the crosslinked well treatment agent may be at least one member selected from the group consisting of paraffin inhibitors, gas hydrate inhibitors, salt formation inhibitors, asphaltene inhibitors and biocides as well as other well treatment agents where slow release into the production well is desired.

The crosslinked well treatment agents may be used in completion or production services. The crosslinked well treatment agents disclosed herein may be used in the well to remove contaminants from or control the formation of contaminants onto tubular surface equipment within the wellbore.

In a preferred embodiment, the crosslinked well treatment agents disclosed herein effectively inhibit, control, prevent or treat the formation of inorganic scale formations being deposited in subterranean formations, such as wellbores, oil wells, gas wells, water wells and geothermal wells. The crosslinked well treatment agents are particularly efficacious in the treatment of scales of calcium, barium, magnesium salts and the like, including barium sulfate, calcium sulfate, and calcium carbonate scales. The crosslinked well treatment agents may further have applicability in the treatment of other inorganic scales, such as zinc sulfide, iron sulfide, etc.

In a preferred embodiment, the crosslinked well treatment agent effectively inhibits corrosion.

The amount of well treatment agent in the crosslinked well treatment agent typically is from about 30 wt % to about 95 wt % and may be from about 50 wt % to about 95 wt %, about 65 wt % to about 95 wt %; and from about 80 wt % to about 95 wt %.

In an embodiment, the crosslinked well treatment agent defined herein comprises at least one well treatment agent—the crosslinkable monomer(s), oligomer(s) or polymer(s)—crosslinked through hydrolysable bonds. Alternatively, the well treatment agent may be the crosslinking agent itself, the crosslinking agent forming hydrolyzable bonds with a crosslinkable component.

In a preferred embodiment, the crosslinked well treatment agent contains crosslinks of ester bonds, amide bonds, imide bonds, phosphoester bonds, or combinations thereof.

In an embodiment, exemplary crosslinkable scale inhibitors are carboxylic acid-containing polymer, organo-phosphorus-containing components and organosulfur-containing components.

In another embodiment, examples of the scale inhibitor include, but are not limited to, polymers, oligomers, and small molecules of carboxylates, aminocarboxylates, acrylates, sulfates, sulfonates, phosphonates, phosphates, phosphate esters, phosphinos, carboxymethyl inulins, polyaspartic acid and copolymers or mixed compounds thereof. The carboxylates, acrylates, sulfates, sulfonates, phosphonates, phosphinos and/or aminocarboxylates may be alkali metal salts. Preferably, the scale inhibitor includes a substantial number of carboxylate groups for crosslinking. The copolymers can be created in either the metal ion salt form or the acid form.

Exemplary scale inhibitors are strong acidic materials and salts thereof such as phosphonate/phosphonic acids, polyacrylamides, salts of acrylamido-methyl propane sulfonate/acrylic acid copolymer (AMPS/AA), salts of sulfonated co-polymer (VS-Co), phosphinated maleic copolymer (PHOS/MA) or sodium salt of polymaleic acid/acrylic acid/acrylamido-methyl propane sulfonate terpolymers (PMA/AMPS).

In an embodiment, the scale inhibitor may comprise polymers, oligomers, or copolymers of at least one anionic, non-ionic or cationic ethylenically unsaturated monomer. In one embodiment, the ethylenically unsaturated anionic monomer comprises acrylic acid, methacrylic acid, maleic acid, itaconic acid, 2-acrylamido-2-methyl propane sulfonic acid, or mixtures thereof.

As used herein, the term “anionic ethylenically unsaturated monomer” means an ethylenically unsaturated monomer which can introduce a negative charge to the polymer that is the scale inhibitor. Suitable anionic ethylenically unsaturated monomers are acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, muconic acid, 2-acryloxypropionic acid, 2-acrylamido-2-methyl propane sulfonic acid, vinyl sulfonic acid, sodium methallyl sulfonate, sulfonated styrene, allyloxybenzene sulfonic acid, vinyl phosphonic acid, maleic acid and combinations thereof. Moieties, such as maleic anhydride or acrylamide, that can be derivatized (hydrolyzed) to moieties with a negative charge are also suitable. The preferred anionic ethylenically unsaturated monomers are acrylic acid, methacrylic acid, maleic acid, itaconic acid and 2-acrylamido-2-methyl propane sulfonic acid.

The non-ionic and cationic ethylenically unsaturated monomers are optional. As used herein, the term “nonionic ethylenically unsaturated monomer” means an ethylenically unsaturated monomer which does not introduce a charge in to the polymer that is the scale inhibitor. These nonionic ethylenically unsaturated monomers include, but are not limited to, acrylamide; methacrylamide; N-alkyl(meth)acrylamide; N,N-dialkyl(meth)acrylamide such as N,N-dimethylacrylamide; hydroxyalkyl(meth)acrylates; alkyl(meth)acrylates such as methylacrylate and methylmethacrylate; vinyl acetate; vinyl morpholine; vinyl pyrrolidone; vinyl caprolactam; ethoxylated alkyl; alkaryl or aryl monomers such as methoxypolyethylene glycol (meth)acrylate; allyl glycidyl ether; allyl alcohol; glycerol (meth)acrylate; monomers containing silane, silanol and siloxane functionalities; and combinations thereof. The nonionic ethylenically unsaturated monomer is preferably water soluble. Preferred nonionic ethylenically unsaturated monomers include acrylamide, methacrylamide, N-methyl(meth)acrylamide, N,N dimethyl(meth)acrylamide, vinyl pyrrolidone and vinyl caprolactam.

An example of a polyacrylate is a low molecular weight polyacrylic acid. Another example is a low molecular weight polymaleic acid. An example of an effective copolymer for scale control is the copolymer of acrylic acid and maleic acid with a mole ratio of 2:1. Other effective scale inhibitors are polymers that contain sulfonate groups. Further, additional monomers especially those useful in mitigating polymer precipitation due to presence of the electrolytes in solution may also be used. Calcium and iron may be considered when selecting the polymers. For example, a copolymer of acrylic acid, maleic acid, methylmethacrylate, and 2-acrylamido-2-methyl propane sulfonic acid is useful in conditions where ion tolerance is required. An example of a polyphosphonate is diethylenetriamine penta(methylene phosphonic acid) (DTPMP); an example of a polyaminocarboxylate is glutamic acid diacetic acid (GLDA); and an example of a small molecule of polycarboxylate is citric acid.

The well treatment agent of the crosslinked well treatment agent may be a salt inhibitor and may include any of the fructans or fructan derivatives, such as inulin and inulin derivatives, as disclosed in U.S. Patent Publication No. 2009/0325825, herein incorporated by reference.

Paraffin inhibitors useful in forming the crosslinked well treatment agent include, but are not limited to, ethylene/vinyl acetate copolymers, acrylates (such as polyacrylate esters and methacrylate esters of fatty alcohols), and olefin/maleic esters.

Exemplary corrosion inhibitors of the crosslinked well treatment agent include but are not limited to fatty imidazolines, alkyl pyridines, alkyl pyridine quaternaries, fatty amine quaternaries and phosphate salts of fatty imidazolines.

Exemplary asphaltene treating inhibitors of the crosslinked well treatment agent include but are not limited to fatty ester homopolymers and copolymers (such as fatty esters of acrylic and methacrylic acid polymers and copolymers).

The crosslinking agent of the crosslinked well treatment agent may be a polyol, a polyamine, an amino alcohol, a polyepoxide, or mixtures thereof. A polyol may be a molecule having 2 or more hydroxyl groups. Examples of a polyol include, but are not limited to, glycerol, 1,6-hexanediol, pentaerythritol, and high molecular weight polyols (e.g., polyvinylalcohol). The polyamine may have two or more amine groups. Examples of a polyamine include, but are not limited to, diethylenetriamine (DETA), tris(2-aminoethyl)amine (tris), 1,6-hexanediamine as well as high molecular weight polyamines (e.g., polyvinylamine, polyethyleneamine, etc.). In one embodiment, at least two of the amine functionalities in the polyamine are primary or secondary. Examples of an amino alcohol include, but are not limited to, ethanolamine, diethanolamine, N-(2-hydroxylethyl)ethylenediamine, and N,N′-bis(2-hydroxyethyl)ethylenediamine. In one embodiment, at least one of the amine functionality in the amino alcohol is not tertiary. Suitable polyepoxides include, but are not limited to, bisepoxides and polyepoxide functional compounds, such as butanediol diglycidyl ether. It should be understood that throughout the present specification, unless otherwise stated, the prefix “poly” encompasses the prefixes “di”, “tri, “oligo”, etc. For example, polyamine includes diamine, triamine, oligoamine, as well as polyamine.

In a preferred embodiment, the crosslinked well treatment agent is a corrosion inhibitor. The crosslinked well treatment agent is formed from the crosslinkable monomer(s), oligomer(s) or polymer(s) and crosslinking agent, where the crosslinking agent acts as corrosion inhibitor upon release from the crosslinked well treatment agent. In a preferred embodiment, the crosslinking agent is an alkyl polyamine containing multiple free amine groups or multiple free alcohol functionalities.

In some cases, the crosslinkable monomer(s), oligomer(s) or polymer(s) exhibits scale inhibiting characteristics and the crosslinking agent serves as corrosion inhibitor. In such cases, upon uncrosslinking scale inhibiting/controlling properties are provided by the released crosslinkable monomer(s), oligomer(s) or polymer(s) and corrosion inhibiting properties are provided by the released crosslinking agent.

Examples of a crosslinking agent that may act as a corrosion inhibitor are alkyl polyamines. Any corrosion inhibitor that contains multiple free amine or multiple free alcohol functionalities may be useful. In one embodiment, the alkyl polyamines are alkyldiamines and/or alkyltriamines. The alkyl polyamines include, but are not limited to, tallow propylenediamine, coco propylenediamine, tallow dipropylene triamine, and coco dipropylene triamine. Further examples of a crosslinking agent that may act as a corrosion inhibitor include, but are not limited to, N-tallow-1,3-diaminopropane, N-tallow-1,3-tallowdiamine, tallow dipropylene triamine, ethoxylated (3) N-coco-1,3-diamine propane, ethoxylated (12) N-tallow-1,3-diamine propane and ethoxylated (2) cocoalkylamines.

Suitable scale inhibitors include those having multiple free amine or multiple alcohol functionalities. Examples of a crosslinking agent include N-(3-aminopropyl)-N-dodecylalkyl trimethylene diamines, distilled, N-coco-1,3-diaminopropane or cocodiamine and tallow dipropylene triamine. Ethoxylated quaternary amines are also useful for their corrosion inhibition.

In another aspect, the crosslinked well treatment agent may include a functional capping agent for the crosslinkable monomer(s), oligomer(s) or polymer(s) which is attached thereto. A capping agent is a molecule having one and only one reactive site, in particular an alcohol or free amine, that can react with an organic acid residue on the well treatment agent and will block that organic acid residue from further reaction. Thus, a capping agent condenses with the organic acid residue on the organic acid-containing well treatment agent, such as scale inhibitor. Upon release/hydrolysis, the capping agent may have certain activities, e.g. corrosion inhibiting activity. Examples of a capping agent that may act as a corrosion inhibitor include, but are not limited to, primary or secondary amines and alcohols as well as primary or secondary amines and alcohols. Examples of a capping agent that act as a corrosion inhibitor include, but are not limited to, coco alkylamines, tallow alkylamines and tall oil imidazoline.

In a further aspect, the crosslinked well treatment agent may include a functional extension agent attached thereto. An extension agent is a molecule that has reactive groups that are self-reactive and which also react with the organic acid residue on the polymeric well treatment agent, such as scale inhibitor. Thus, the extension agent is a molecule that has complementary reactive groups with respect to condensation reaction, one of which can react with the organic acid residue on the polymer and in particular an alcohol or free amine. Upon release/hydrolysis, the extension agent may exhibit have certain activities, e.g., scale inhibition. Examples of an extension agent that functions as a scale inhibitor is lactic acid.

A reducing agent may optionally be added to the mixture containing the crosslinkable monomer(s), oligomer(s) or polymer(s) and crosslinking agent to promote crosslinking. Examples of a reducing agent include, but are not limited to, sodium hypophosphonate.

The crosslinked well treatment agent has controlled release properties. The particle has a slow release rate in water which increases with increasing temperature, pH conditions and other downhole factors. In one embodiment, the well treatment agent is released from the crosslinked well treatment agent continuously for a period of up to about 12 months at a temperature of up to about 200° C. In another embodiment, the well treatment is released from the crosslinked well treatment agent continuously over a period from 3 months to about 12 months at a temperature of up to about 150° C.

The crosslinkable monomer(s), oligomer(s) or polymer(s) may be linked with different crosslinking agents to provide a specific release profile versus time and temperature. For example, a polyol (e.g., glycerol) crosslinking agent provides a faster release profile; meanwhile, a polyamine crosslinking agent (e.g. diethylenetriamine) provides a slower release profile. Mixed amino alcohols can also be used, such as ethanolamine, diethanolamine, N-(2-hydroxylethyl)ethylenediamine, or N,N′-bis(2-hydroxyethyl)ethylenediamine. Mixtures of crosslinking agents and crosslinkable monomer(s), oligomer(s) or polymer(s) can be used to control the ultimate release and dissolution rate of the well treatment agent.

In an embodiment, a crosslinked well treatment agent having controlled release properties is provided wherein the crosslinking agent and the crosslinkable monomer(s), oligomer(s) or polymer(s) is selected based on the desired controlled release profile. As used herein, “controlled release” means the attribute indicating that a desired substance, in this case the crosslinkable monomer(s), oligomer(s) or polymer(s) or crosslinking agent, is released to the target environment in a controlled fashion, rather than immediately or instantaneously. It is understood that the crosslinkable monomer(s), oligomer(s) or polymer(s) or crosslinking agent may be released over a period of time, typically in excess of six months, in cases over a period of tune of at least 18 months and in some cases in excess of three years.

The crosslinked well treatment agent may be prepared by mixing the crosslinkable monomer(s), oligomer(s) or polymer(s) and crosslinking agent; subjecting the mixture to a temperature from about 20° C. to about 250° C. for up to about 72 hours; and then sizing the mixture to obtain a particle size from about 5 microns to about 4000 microns.

The pH of the mixture of crosslinkable monomer(s), oligomer(s) or polymer(s) and crosslinking agent may be adjusted to a pH optimum for crosslinking. In an embodiment, the pH of the mixture of crosslinkable monomer(s), oligomer(s) or polymer(s) and crosslinking agent may be adjusted to a pH from about 2 to about 6. In an embodiment, where the crosslinking agent is a polyamine or a mixture of polyamine and polyol and the well treatment agent is a scale inhibitor, the pH of the mixture may be between from about 3.5 to about 5. In another embodiment, where the crosslinking agent is a polyol and the well treatment agent is a scale inhibitor, the pH of the mixture may be from about 2 to about 4. An acid may be added to the mixture to achieve the desired pH level and if added, the acid may be added in the mixing step. Acids suitable for use in the method include strong inorganic acids such as hydrochloric acid and sulfuric acid.

The mixture of crosslinkable monomer(s), oligomer(s) or polymer(s) and crosslinking agent may be subjected to a temperature from about 20° C. to about 250° C. for up to about 72 hours. In an embodiment, the mixture is subjected to a temperature from about 150° C. to about 250° C. for about 5 seconds to about 3 hours. In another embodiment, the mixture is subjected to a temperature from about 170° C. to about 200° C. for about 5 seconds to about 2 hours; in yet another embodiment from about 170° C. to about 200° C. for about 1 to 2 hours. The heating may be performed by placing the material in a vessel from which water vapor can be removed. Heat can be provided to the vessel by steam, hot water, heated heat exchange fluids, or electrical heating elements. In addition, the mixture may first be spray atomized into droplets which are heated in a hot air stream, such as in a spray dryer. During the temperature subjecting step, the mixture may be first subjected to drying at temperatures from about 50° C. to about 1 hour. Further details of the process of making the crosslinked well treatment agent may be found in U.S. Patent Publication No. 2014/0338915, herein incorporated by reference.

During the portion of the temperature subjecting step after drying, the mixture is cured by crosslinking. To complete crosslinking, a sufficient temperature to activate the crosslinking chemical reaction is required. Typically, the temperature required to activate appreciable crosslinking is from 150° C. to about 180° C. Since the crosslinking reaction is a condensation reaction and releases water as a by-product, water used as a solvent for the mixture is predominately removed before the curing step. Typical water levels present at the beginning of the temperature subjecting step leading to crosslinking are less than about 15 wt % of water.

A crosslinked well treatment agent may be introduced into the well as a component of a well treatment composite. Such composites may comprise the crosslinked well treatment agent associated with a substrate. As used herein, the term “associated” refers to the nexus between the crosslinked treatment agent and the substrate which enables crosslinked well treatment agent to be combined to form a composite. The term “associated” shall not be restricted however to a chemical reaction between the crosslinked treatment agent and the substrate. As discussed further, the term may refer to adsorption of the crosslinked well treatment agent onto the substrate, absorption of the crosslinked well treatment agent into the matrix of the substrate, absorption into or adsorption of the crosslinked well treatment agent onto the pores of the substrate, immobilization of the crosslinked well treatment agent on the substrate, etc. Over time, the well treatment agent is released from the crosslinked well treatment agent and disassociates from the substrate under in-situ conditions.

Typically, the specific gravity of the composite is less than or equal to 3.75 g/cc.

The amount of crosslinked well treatment agent in the composite is that amount sufficient to effectuate the desired release into the flowing produced fluid over a sustained period of time. The composite does not require excessive amounts of the crosslinked well treatment agent. The amount of crosslinked well treatment agent in the composite is that amount sufficient to effectuate the desired result over a sustained period of time and may be as low as 1 ppm. In some embodiments, the amount of crosslinked well treatment agent in the composite is normally from about 1 to 50 weight percent, preferably from about 14 to about 40 weight percent.

An exemplary well treatment composite for use herein may be a crosslinked well treatment agent immobilized on a support. These include those wherein the crosslinked well treatment agent is adsorbed onto the surface of the substrate. In another embodiment, the crosslinked well treatment agent may be absorbed into the pores of the substrate. In another embodiment, the crosslinked well treatment agent may be impregnated within the substrate.

For instance, in an embodiment, the crosslinked well treatment agent may be adsorbed onto a water insoluble adsorbent to form a composite. When fluid is produced, the well treatment agent may desorb into a solubilizing liquid after being uncrosslinked and released from the substrate. For instance, where a crosslinked well treatment agent is an inhibitor for scales, corrosion, salts or biocidal action, the treatment agent may desorb into produced water upon being released from the adsorbent. In the absence of water flow, the crosslinked well treatment agent may remain intact on the solid adsorbent. As another example, solid inhibitors for paraffin or asphaltene may desorb from the substrate into the hydrocarbon phase of produced fluid.

Adsorption of the crosslinked well treatment agent onto the adsorbent reduces (or eliminates) the amount of well treatment agent required to be in solution. Since the crosslinked well treatment agent is adsorbent onto a substrate, only a small amount of well treatment agent may be released into the aqueous medium.

Preferred water insoluble adsorbents are those commercially available high surface area materials having the affinity to adsorb the crosslinked well treatment agent. Typically, the surface area of the adsorbent is between from about 1 m²/g to about 100 m²/g.

Suitable adsorbents include finely divided minerals, fibers, ground almond shells, ground walnut shells, and ground coconut shells. Further suitable water-insoluble adsorbents include activated carbon and/or coals, silica particulates, precipitated silicas, silica (quartz sand), alumina, silica-alumina such as silica gel, mica, silicate, e.g., orthosilicates or metasilicates, calcium silicate, sand (e.g., 20-40 mesh), bauxite, kaolin, talc, zirconia, boron and glass, including glass microspheres or beads, fly ash, zeolites, diatomaceous earth, ground walnut shells, fuller's earth and organic synthetic high molecular weight water-insoluble adsorbents. Particularly preferred are diatomaceous earth and ground walnut shells.

Further useful as adsorbents are clays such as natural clays, preferably those having a relatively large negatively charged surface, and a much smaller surface that is positively charged. Other examples of such high surface area materials include such clays as bentonite, illite, montmorillonite and synthetic clays.

The weight ratio of the crosslinked well treatment agent to water-insoluble adsorbent in the composite is generally between from about 90:10 to about 10:90. The amount of crosslinked well treatment agent in the composite is that amount sufficient to effectuate the desired release of well treatment agent into the flowing produced fluid over a sustained period. Generally, the amount of crosslinked well treatment agent released from the adsorbent through uncrosslinking is from about 0.05 to about 5 (preferably from about 0.1 to about 2) weight percent based upon the total weight of flowing produced fluid. In some instances, the amount of well treatment agent released into the produced fluid may be as low as 0.1 ppm.

Such composites may be prepared in accordance with the teachings set forth in U.S. Pat. Nos. 7,491,682; 7,493,955; or 7,494,711, herein incorporated by reference.

The adsorption of the liquid (or solution of) crosslinked well treatment agent onto the solid adsorbent limits the availability of the free well treatment agent in water. In addition, the composite itself has limited solubility in water. When placed into a production well, the well treatment agent of the crosslinked well treatment agent slowly dissolves as the oilfield fluid passes through or circulates around the well treatment composites, the well treatment agent slowly desorbs. In so doing, the composites are characterized by time-release capabilities and the well treatment agent is released at a generally constant rate over an extended period in the water which is contained in the formation. The controlled slow release of the agent is dependent upon the surface charges between the crosslinked well treatment agent and adsorbent which, in turn, is dependent upon the adsorption/desorption properties of the well treatment agent to adsorbent.

Gradual desorption of the well treatment agents insures that they are available to produced fluids for extended periods of time, typically extending for periods of time greater than a year and even as long as five years. Thus, the lifetime of a single treatment using the composite may be between 12 months and in excess of 5 years.

Another exemplary well treatment composite for use herein may be composed of a porous particulate and at least one well treatment agent. The well treatment agent is preferably hydrocarbon-soluble or water-soluble. The porosity and permeability of the porous particulate is such that the crosslinked well treatment agent may be absorbed into or adsorbed within the interstitial spaces of the porous particulate material.

Typically, the particle size of the porous particulate of such composites is typically between from about 0.3 mm to about 5 mm, preferably between from about 0.4 to about 2 mm.

Typically, the porosity of the porous particulate is between from about 5 to about 30 volume percent. A commercially available instrument which uses mercury intrusion, such as the AutoPore Mercury Porosimeter (Micromeritics, Norcross, Ga.), for measuring the internal porosity of the particulate and the interstitial volume (of a pack) may be used to determine the porosity of the porous particulate. Examples of types of materials suitable for use as porous particulates include particulates having a porous matrix.

The porous particulates are generally spherical and insoluble in well fluids under subterranean conditions, such as at temperatures less than about 250° C. and pressures less than about 80 MPa. The particulates may be sufficiently strong to be used on their own at high pressures. They may further be used in conjunction with other well treatment agents including non-porous proppant materials, such as sand.

The porous particulate is preferably an untreated porous ceramic, of inorganic oxide or an organic polymeric material. Suitable porous particulates include aluminosilicates, silicon carbide, alumina and other silica-based materials.

In an embodiment, the porous particulate of the composite may be any naturally occurring or manufactured or engineered porous ceramic particulate, as well as any organic polymeric material, that has an inherent and/or induced porosity and exhibits the requisite physical properties, such as particle characteristics, desired strength and/or apparent density, to fit particular downhole conditions for well treating.

The porous ceramic particulates may be selectively manufactured from raw materials such as those described in U.S. Pat. No. 5,188,175; U.S. Pat. No. 4,427,068; and U.S. Pat. No. 4,522,731, which are each incorporated herein by reference, such as by inclusion of selected process steps in the initial material manufacturing process to result in a material that possesses desired characteristics of porosity, permeability, apparent density or apparent specific gravity (ASG) and combinations thereof.

The porous particulate may be selected so to exhibit crush resistance under conditions as high as 10,000 psi closure stress, API RP 56 or API RP 60, generally between from about 250 to about 8,000 psi closure stress. Thus, the composite may be used in hydraulic fracturing or in a sand control operation and may effectively be used as a proppant.

Suitable as inorganic ceramic materials are alumina, magnetic glass, titanium oxide, zirconium oxide, silicon carbide, aluminosilicates and other silica-based materials.

Examples of non-natural porous particulate materials for use herein include, but are not limited to, porous ceramic particles, such as fired kaolinitic particles, as well as partially sintered bauxite. The porous particulates may further be porous natural ceramic materials, such as lightweight volcanic rocks, formations, such as wellbores, oil wells, gas wells, water wells and geothermal wells. The composites of the invention are particularly efficacious in the treatment of scales of calcium, barium, magnesium salts and the like, including barium sulfate, calcium sulfate, and calcium carbonate scales. The composites may further have applicability in the treatment of other inorganic scales, such as zinc sulfide, iron sulfide, etc. pumice, as well as perlite and other porous “lavas” like porous (vesicular) Hawaiian Basalt, porous Virginia Diabase and Utah Rhyolite. Such naturally occurring materials may be strengthened or hardened by use of modifying agents to increase the ability of the naturally occurring material to resist deformation. A starch binder may be employed.

Suitable polymeric materials for use as the porous particulate include thermosetting resins, such as polystyrene, a styrene-divinylbenzene copolymer, a polyacrylate, a polyalkylacrylate, a polyacrylate ester, a polyalkyl acrylate ester, a modified starch, a polyepoxide, a polyurethane, a polyisocyanate, a phenol formaldehyde resin, a furan resin, or a melamine formaldehyde resin.

In a preferred embodiment, the porous particulate is a relatively lightweight or substantially neutral buoyant particulate material. The term “relatively lightweight” shall refer to a particulate that has an ASG (API RP 56) that is substantially less than a conventional particulate material employed in hydraulic fracturing or sand control operations, e.g., sand (having an ASG, API RP 60, of 2.65) or bauxite (having an ASG of 3.55). The ASG of a relatively lightweight material is preferably less than about 2.4, more preferably less than or equal to 2.0, even more preferably less than or equal to 1.75, most preferably less than or equal to 1.25.

Further, blends of the composites may be used for achieving desired well treatment results and/or costs. Blends may consist of the referenced porous particulates as well as particulates not included within the porous particulates described herein. Particle types which may be selected for use in such blends include such non-porous particulates like conventional sand, such as Ottawa sand.

In another embodiment, the well treatment composite is characterized by a calcined porous substrate prepared from nano-sized material onto which may be adsorbed at least one crosslinked well treatment agent as defined herein.

Suitable calcined porous substrates are those set forth in U.S. Pat. No. 9,029,300, herein incorporated by reference.

The porosity and permeability of the calcined porous substrate is such that the crosslinked well treatment agent may also be absorbed into the interstitial spaces of the porous substrate. Typically, the surface area of the calcined porous substrate is between from about 1 m²/g to about 10 m²/g, preferably between from about 1.5 m²/g to about 4 m²/g, the diameter of the calcined porous substrate is between from about 0.1 to about 3 mm, preferably between from about 150 to about 1780 micrometers, and the pore volume of the calcined porous substrate is between from about 0.01 to about 0.10 g/cc.

The porosity and permeability of the calcined porous substrate may be such that the crosslinked well treatment agent may also be absorbed into the interstitial spaces of the porous substrate. In a preferred embodiment, the amount of crosslinked well treatment agent in the composite is normally from about 1 to 50 weight percent, preferably from about 14 to about 40 weight percent.

The calcined porous metal oxide substrate is typically spherical and insoluble in well fluids under subterranean conditions, such as at temperatures less than about 250° C. and pressures less than about 80 MPa.

The porous substrate may be a metal oxide, such as alumina, zirconium oxide and titanium oxide. Typically, the porous substrate is alumina.

Such composites may be employed alone as a fracture proppant/sand control particulate, or in mixtures in amounts and with types of fracture proppant/sand control materials, such as conventional fracture or sand control particulates. In such applications, the composite may be used in conjunction with conventional proppants or sand control particulates.

When placed into a well, the crosslinked well treatment agent slowly is uncrosslinked causing the well treatment agent to dissolve at a generally constant rate over an extended period of time in the water or hydrocarbons which are contained in the formation and/or well. The composite therefore permits a continuous supply of the well treatment agent into the targeted area.

In a preferred embodiment, the crosslinked well treatment agent is formed into a shaped compressed pellet. The crosslinked well treatment agent may or may not be associated with a substrate as discussed herein. The well treatment agent is slowly released from the shaped compressed pellet as the crosslinking agent and crosslinkable monomer(s), oligomer(s) or polymer(s) are uncrosslinked after being introduced into a targeted area in the well. The targeted area may be a site in the well where deposits have already formed or a location in the well where it is desirable for deposits not to form. The compressed pellets provide a continuous supply of the well treatment agent after uncrosslinking into the targeted area.

The specific gravity of the shaped compressed pellet is generally between from about 1.1 to about 3. In a preferred embodiment, the specific gravity of the shaped compressed pellet is between from about 2 to about 2.5. Such specific gravity is especially desirable when the shaped compressed pellets are spherical and where it is desired to drop them directly into the well head.

Typically, the shaped compressed pellets contain a weighting agent to increase the specific gravity of the article.

Though a binder is not required to form the compressed pellet, a binder and/or a weighting agent is typically employed. The binder, to which the crosslinked well treatment agent (optionally as a composite) is added, generally serves to hold the crosslinked well treatment agent and any desired additives agents together during compression. Suitable binders may be an organic binder or inorganic binder. Typical organic binders are those selected from resole or novolac resins, such as phenolic resole or novolac resins, epoxy-modified novolac resins, epoxy resins, polyurethane resins, alkaline modified phenolic resoles curable with an ester, melamine resins, urea-aldehyde resins, urea-phenol-aldehyde resins, furans, synthetic rubbers, silanes, siloxanes, polyisocyanates, polyepoxys, polymethylmethacrylates, methyl celluloses, crosslink entangled polystyrene divinylbenzenes, and plastics of such polymers as polyesters, polyamides, polyimides, polyethylenes, polypropylenes, polystyrenes, polyolefins, polyvinyl alcohols, polyvinylacetates, silyl-modified polyamides and, optionally, a crosslinking agent. Typical inorganic binders include silicates, e.g., sodium silicate, aluminosilicates, phosphates, e.g., polyphosphate glass, borates, or mixtures thereof, e.g., silicate and phosphate.

The amount of binder added to the crosslinked well treatment agent to form the shaped compressed pellet is typically from about 0.5 to about 50, preferably from about 1 to about 5 percent based on the total weight of the binder and the crosslinked scale inhibitor (or composite) prior to compression.

The weighting agent, when present, imparts to the shaped compressed pellets higher specific gravity. When present, the amount of weighting agent in the shaped compressed pellet is that amount needed to adjust the specific gravity of the article to the requirements of the treated well. Suitable weighting agents include sand, glass, hematite, silica, sand, aluminosilicate, and an alkali metal salt or trimanganese tetraoxide.

The shaped compressed pellets may be produced by procedures known in the art. Typically, the shaped compressed pellets are formed by combining the crosslinked well treatment agent (optionally as a composite) and, optional, weighting agent and/or binder and then compressing the mixture in a mold of the desired shape or extruding the mixture into its desired shape.

Exemplary of the process for making the shaped particulates is to combine the components with an organic binder and then compressing the mixture at a temperature between from about 20° C. to about 50° C. at a pressure of from between 50 to about 5000 psi. The hardened particulates may then be screened to the desired size and shape. In another preferred embodiment, the shaped compressed pellets are produced by a continuous extrusion at a temperature between from about 400° C. to about and 800° C.

The shaped compressed pellets may further be coated with a resin, plastic or sealant which is resistant to the hydrocarbons produced in the well. Suitable resins include phenolic resins like phenol formaldehyde resins, melamine formaldehyde resins, urethane resins, epoxy resins, polyamides, such as nylon, polyethylene, polystyrene, furan resins or a combination thereof.

The coating layer serves to strengthen the shaped compressed pellet, protect the article from harsh environmental conditions, protect the article from rupturing as it is lowered into the well and to lengthen the time of uncrosslinking of the well treatment agent. The coating layer may be applied to the shaped compressed pellet by mixing the shaped compressed pellet and coating material in a vessel at elevated temperatures, typically from about 200 to about 350, preferably around 250° F. Alternatively, the coating layer may also be applied as a spray in a solvent based coating on the shaped compressed pellet and then dried to remove the solvent.

The shaped compressed pellets have applicability in areas within the well where conventional systems have been unable to reach. A major advantage of the shaped compressed pellets is that their introduction into the well does not typically require any specialized equipment. They are especially useful in the treatment of production wells where traditional mechanical means are unable to reach.

The shaped compressed pellets are especially useful when introduced into horizontal or deviated wells since they easily pass through restrictions in the wellbore and flow into low points of the horizontal well or past obstruction in a deviated well.

When shaped as spheres, the shaped compressed pellets can readily roll over obstructions within the tubing and through well deviations to effectively place the well treatment agent near the targeted area. The spheres are especially useful in delivering well treatment agents in wells having deviations ranging from 45° to 89° or in wells with multiple deviations such as “S” shaped completions.

When formed to resemble hockey pucks, the shaped compressed pellets may be placed into a receptacle and suspended at distant locations within the well. When the well treatment agent is depleted within the receptacle, the receptacle may then be pulled to the surface and reloaded with additional pellets.

Use of the shaped compressed pellets renders unnecessary the use of burdensome mechanical tools and procedures. While the shaped compressed pellets may be used to treat any type of well that requires chemical treatment, they have applicability in the treatment of production wells where traditional mechanical means such as wire lines or coil tubing have been unable to reach. For instance, the shaped compressed pellets may be introduced directly into production tubing by being dropped directly into the well head or may be placed in a receptacle and lowered into the well.

The shaped compressed pellets may be shaped such as in the form of a sphere, cylinder, rod, or any other shape which allows for the slow release of the well treatment agent into the targeted area. Typically, the shaped compressed pellet particle size is typically from about 5 to about 80,000 microns, preferably from about 400 microns to about 40,000 microns, more preferably from about 500 microns to about 35,000 microns, most preferably from about 600 microns to about 32,000 microns and in some cases from about 4,000 microns to about 30,000 microns. In some applications, the shaped pellets are cylindrically shaped having a length of about 0.5 inch to about 6 inches, preferably from about 1 inch to about 2 inches and a diameter of from about 0.25 inch to about 4 inches, preferably from about 0.5 inch to about 1 inch.

In those instances where the shaped compressed pellet is to be directly dropped into the well from the well head, the shaped compressed pellet is preferably spherical and is formed into a ball-like sphere having a diameter between from about ½ inch to about 3 inches, more preferably from about ¾ inch to about 2½ inches, most preferably approximately 1¾ inch. Such spheres resemble spherical balls.

When introduced into production tubing within the well, the shape and specific gravity of the shaped compressed pellets causes them to flow past obstructions and through well deviations such that the shaped compressed pellets may be placed at or in close proximity to the targeted area where treatment is desired. Continuous release of the well treatment agent (after uncrosslinking) into the production fluid further protects the tubular and the surface equipment from unwanted deposits which may otherwise be formed. Production from the well is thereby improved.

Similar performance has been seen in producing wells where the shaped compressed pellets are used simply to deploy production chemicals, particularly in horizontal wells where capillary deployment is not possible to the toe of the horizontal section of the well or where squeeze treatments are impractical; for example, in wells which have not been stimulated.

The shaped compressed pellets may be dropped directly into the well from the well head. When introduced into production tubing within an oil or gas well, the shaped compressed pellets easily flow past obstructions and through well deviations. Continuous release of the well treatment agent with the production fluid protects the tubular and the surface equipment from unwanted deposits which may be formed in the tubular or surface equipment. The high specific gravity of the shaped compressed pellets allows them to pass by gravity into and through production tubing.

When used as one or more spherical balls, the shaped compressed pellets may be introduced into the well above the master valve at the wellhead. The isolation valve above the spherical ball(s) may then be closed and the master valve then opened. Gravitational forces will pull the ball(s) into the production tubing. The low specific gravity allows the sphere(s) to fall by gravitational forces through the production tubing. The combination of gravitational forces, specific gravity of the ball(s), sphericity of the ball(s) and size then allow the ball(s) to fall, sink or roll down the tubing and pass through restrictions in the wellbore. When introduced into a horizontal well, the spherical ball(s) will generally flow into the lowest point of the well. When introduced into a deviated well, the spherical pellets easily may flow past obstructions as they are pulled by gravity through the deviations in the well path where traditional mechanical means such as wire line or coil tubing may not be able to reach. The shaped pellets have applicability when used during completion of a well having multiple deviations such as those wells having an “S” shaped configuration. Once the spherical ball(s) reach their targeted area, they will slowly dissolve, providing a residual of the well treatment agent in produced fluids. Thus, the slow dissolution of the ball(s) provides the means to inhibit and/or remove unwanted deposits in the tubing.

When dropped directly into the well head, it is often only necessary to use one spherical ball. Typically, no more than ten spherical balls need be used to effectuate the slow release of the well treatment agent. Slow dissolution of the spherical balls permits slow dissolution of the well treatment agent.

The shaped compressed pellets further are useful in gas wells having a tubing pressure of from about 1 to about 10,000 psi. Exemplary of such wells are shale gas wells. Further the shaped compressed pellets have applicability in unobstructed tubulars. For instance, the shaped compressed pellets are useful in those wells where the hydrocarbons are no longer freely flowing, such as wells on bottom hole electric submersible pumps (ESP).

In another preferred embodiment, the shaped compressed pellets may be simply lowered into the well. For instance, they may be placed into a receptacle, such as a wire basket, and suspended at the bottom of the well by various means, such as by a wireline or by being hung to the bottom of a rod pump. When uncrosslinking of the crosslinking agent from the well treatment agent is substantially complete, the wire basket may then be pulled to the surface and reloaded with additional compressed materials for further treatment.

In another embodiment, the shaped compressed pellets may be placed into a receptacle and the receptacle then affixed to the bottom of a bottom hole electric submersible pump by hanging the receptacle from the bottom of the bottom hole electric submersible pump. The bottom hole electric submersible pump with the affixed receptacle may then be lowered into the well.

The shaped compressed pellets may be a component of a fracturing fluid or acidizing fluid, such as a matrix acidizing fluid. The shaped compressed pellets may be used in completion or production services. The pellets may have particular applicability in completion fluids containing zinc bromide, calcium bromide calcium chloride and sodium bromide brines. The shaped compressed pellets may be used in the well to remove contaminants from or control the formation of contaminants onto tubular surface equipment within the wellbore

The pellets may be used in combination with conventional proppants or sand control particulates. The pellets are particularly effective in hydraulic fracturing as well as sand control fluids such as water, salt brine, slickwater such as slick water fracture treatments at relatively low concentrations to achieve partial monolayer fractures, low concentration polymer gel fluids (linear or crosslinked), foams (with gas) fluid, liquid gas such as liquid carbon dioxide fracture treatments for deeper proppant penetration, treatments for water sensitive zones, and treatments for gas storage wells.

When used in hydraulic fracturing, the composite may be injected into a subterranean formation in conjunction with a hydraulic fracturing fluid at pressures sufficiently high enough to cause the formation or enlargement of fractures. Since the particulates may withstand temperatures greater than about 370° C. and closure stresses greater than about 8000 psi, they may be employed as the proppant particulate. Alternatively, the composite may be employed in conjunction with a conventional proppant. Since the porous particulate of the composite is insoluble, the composite may continue to function as a proppant even after the well treatment agent has been completely leached out of the composite.

The crosslinked well treatment agent by itself or as a component of a composite may be transported into the well as a composition in a carrier or treatment fluid to facilitate placement to a desired location within the well or formation. In this regard, any carrier fluid suitable for transporting the crosslinked well treatment agent may be used. Well treatment compositions containing the crosslinked well treatment agent may be gelled or non-gelled.

In one embodiment, the crosslinked well treatment agent described herein may be introduced or pumped into a well as neutrally buoyant particles in, for example, a saturated sodium chloride solution carrier fluid or a carrier fluid that is any other completion or workover brine known in the art.

Suitable carrier fluids include or may be used in combination with fluids have gelling agents, gel breakers, surfactants, foaming agents, demulsifiers, buffers, clay stabilizers, acids, or mixtures thereof.

The crosslinked well treatment agent by itself or in the form of a composite may further be advantageously employed in liquefied gas and foamed gas carrier fluids, such as liquid carbon dioxide, carbon dioxide/nitrogen and foamed nitrogen in carbon dioxide based systems.

The carrier fluid may be a brine (such as a saturated potassium chloride or sodium chloride solution), salt water, fresh water, a liquid hydrocarbon, or a gas such as nitrogen or carbon dioxide.

The amount of well treatment agent or, when present in the form of a composite, the amount of composite present in the well treating composition is typically between from about 15 ppm to about 100,000 ppm depending upon the severity of the scale deposition.

In an embodiment, the crosslinked well treatment agent is introduced into the well within a screen. The screen is placed in the well. The openings in the screen are sufficiently small to prevent the crosslinked well treatment agent (or composite containing the crosslinked well treatment agent) from entering the well. Upon uncrosslinking and release of the well treatment agent, the well treatment agent flows through the openings of the screen into the well while the substrate remains within the screen assembly.

When the screen is placed into a well, the crosslinked well treatment agent is gradually uncrosslinked and the well treatment agent slowly dissolves at a generally constant rate over an extended period in the water or hydrocarbons in which the screen assembly is contained. Uncrosslinking between the crosslinking agent and crosslinkable monomer(s), oligomer(s) or polymer(s) occurs as the oilfield fluid passes through or circulates around the composite.

The gradual uncrosslinking of the crosslinked well treatment agent and separation of the well treatment agent from the substrate insures delivery of the well treatment agent to produced fluids provides for a continuous supply of the well treatment agent into the targeted area. As such, the lifetime of a single treatment is between six and twelve months and may be more than 3 years. The lifetime of a single treatment is longer in those cases where the crosslinked well treatment agent is introduced into the screen assembly in the form of a composite.

In a preferred embodiment, the openings (mesh) in the screen is sufficiently small to prevent the shaped compressed pellet containing the crosslinked well treatment agent from entering the well. After the crosslinked well treatment agent is hydrolyzed and uncrosslinked, the released well treatment agent flows through the openings of the screen. The mesh of the screen is larger than the size of the released well treatment agent to enable passage of the released well treatment agent into the well.

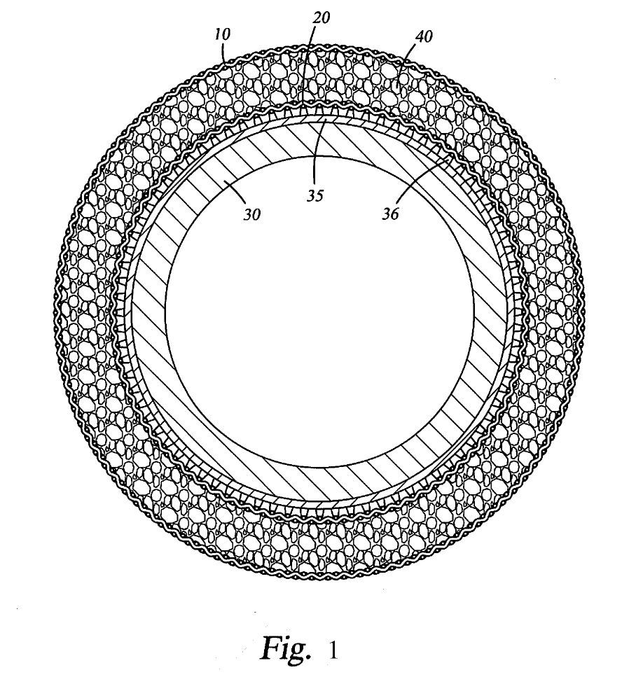

The screen described herein may be a component of a screen assembly. FIG. 1 is a typical screen assembly which may be used. Referring to FIG. 1, the screen assembly contains a screen which may be composed of multiple layers of wire 10 and 20; wire 10 and wire 20 forming the outer screen and inner screen, respectively, of the screen. The wire layers are wrapped around base pipe 30 connected to the lower end of a string of tubing. Multiple spacer bars 36 may be provided between sleeve 35 and inner wire as well. One or more spacer bars may also be between sleeve 35 and base pipe 30. Composite 40 is typically packed within the screen to provide a fluid-permeable matrix within. The diameter of the opening in the screen (mesh) are smaller than the diameter of the substrate of the composite. Thus, the openings can reduce or substantially prevent the passage of the substrate from the screen into the wellbore while at the same time allowing passage of the well treatment agent after hydrolysis from the screen into the wellbore.

The screen assembly may further contain multiple layers of wrapped wires. For instance, the screen assembly may be composed of an inner wire layer, an outer layer and an intermediate layer. A spacer bar or rib may hold the intermediate layer from the inner layer as well as holding intermediate layer from the outer layer.

Various configurations of screens and screen assemblies are known in the art and may be used provided the mesh size of the screen is small enough to retain the substrate of the composite within the screen while permitting the flow of well treatment agent into the fluids within the well. Such fluids include the aqueous fluid water or hydrocarbon liquid contained in the subterranean formation.

The screen assembly is particularly effective in completion or production services as in the removal of contaminants from the well and formation, control the formation of contaminants or retarding the release of contaminants into the well. Further, the crosslinked well treatment agents may be used in the well to remove contaminants from or control the formation of contaminates onto tubular surface equipment within the wellbore.

Typically, the screen is placed into the well after the well has been stimulated and after the start of production of hydrocarbons from the well.

In a preferred embodiment, the well is killed by placing a heavy fluid or mud (“kill mud”) into the wellbore to suppress the pressure of the reservoir fluids and thus prevent flow of the reservoir fluids. After the well kill, the screen is lowered into the well. Production of the well may be resumed at a later point.

In another embodiment, the well may be shut-in after completion of pumping. The screen may then be inserted into the well during shut-in or shortly thereafter and prior to resuming of pumping of fluids into the well.

In a preferred embodiment, the screen is placed into an open (uncased) well.

In another embodiment, a composite containing the crosslinked well treatment agent may be used to pre-pack a screen for use in gravel packed wells. A screen assembly known in the art may be placed or otherwise disposed within the wellbore so that at least a portion of the screen assembly is disposed adjacent the subterranean formation. In this embodiment, the composite is preferably placed as close to the point of equilibrium as possible to ensure the continuous release of the well treatment agent upon uncrosslinking throughout the producing flow stream. A slurry including the composite and a carrier fluid may then be introduced into the wellbore and placed adjacent the subterranean formation by circulation or other suitable method so as to form a fluid-permeable pack in an annular area between the exterior of the screen and the interior of the wellbore that is capable of reducing or substantially preventing the passage of formation particles from the subterranean formation into the wellbore during production of fluids from the formation, while at the same time allowing passage of formation fluids from the subterranean formation through the screen into the wellbore. It is possible that the slurry may contain all or only a portion of the composite; the balance of the slurry may be another material, such as a conventional gravel pack particulate.

All percentages set forth in the Examples are given in terms of weight units except as may otherwise be indicated.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of appended claims.

What is claimed is:

1. A method of inhibiting or controlling the rate of release of a well treatment agent in a well comprising (i) introducing into the well a shaped compressed pellet comprising a crosslinked well treatment agent having hydrolysable bonds, the crosslinked well treatment agent being the product of one or more crosslinking agents and a crosslinkable monomer, oligomer, polymer or a mixture thereof and wherein the well treatment agent of the crosslinked well treatment agent is either the crosslinking agent or the crosslinkable monomer, oligomer, polymer or mixture thereof; and (ii) releasing the well treatment agent from the shaped compressed pellet by hydrolyzing the hydrolysable bonds over a period of time.

2. The method of claim 1, wherein the shaped compressed pellet is preparing by compressing the crosslinked entity directly, or with a binder, a weighting agent or both a binder and a weighting agent.

3. The method of claim 1, wherein the shaped compressed pellet is spherical or cylindrical.

4. The method of claim 1, wherein the crosslinking agent of the crosslinked well treatment agent is a corrosion inhibitor.

5. The method of claim 1, wherein the well treatment agent is the crosslinkable monomer, oligomer, polymer or mixture thereof and further wherein the well treatment agent is a scale inhibitor.

6. The method of claim 1, wherein the shaped compressed pellet has a lifetime, from a single treatment, of at least six months.

7. The method of claim 1, wherein the hydrolysable bonds are ester bonds, amide bonds, imide bonds, phosphoester bonds or a combination thereof.

8. The method of claim 1, wherein the size of the shaped compressed pellet is from about 4,000 microns to about 80,000 microns.

9. The method of claim 1, wherein at least one of the following conditions prevail:
(a) the shaped compressed pellet is directly dropped into the well from the well head;
(b) the shaped compressed pellet is directly dropped into the production tubing within the well;
(c) the shaped compressed pellet is introduced into the well in a receptacle and further wherein the receptacle is suspended in the well to a targeted area; or
(d) the shaped compressed pellet is affixed to the bottom of a bottom hole electric submersible pump and lowered into the well.

10. The method of claim 1, wherein the shaped compressed pellet is placed into the interior of a screen assembly wherein (i) the diameter of the shaped compressed pellet is greater than the diameter of the openings of the screen assembly; (ii) the hydrolysable bonds of the crosslinked well treatment agent are hydrolyzed over time; (iii) the well treatment agent is released from the shaped compressed pellet upon hydrolysis of the hydrolysable bonds; and (iv) the released well treatment agent is passed from the shaped compressed pellet into the well or the subterranean formation through the openings of the screen assembly wherein the openings of the screen assembly are greater than the diameter of the released well treatment agent.

11. The method of claim 10, wherein either:
(a) the well into which the shaped compressed pellet is placed is a killed well;
(b) the screen assembly with the shaped compressed pellet is introduced into the well after the subterranean formation has been stimulated; or
(c) the well is shut-in after stimulation and during shut-in the screen assembly with the shaped compressed pellet is introduced into the well.

12. A method of continuously releasing a well treatment agent into a well, the method comprising:
(a) introducing into the well a screen having a well treatment agent within its interior wherein the well treatment agent is crosslinked by hydrolysable bonds and the mesh of the screen is sufficient to restrain flow of the crosslinked well treatment agent from the interior of the screen into reservoir fluids and further wherein the mesh of the screen is sufficient for the well treatment agent to flow from the interior of the screen into reservoir fluids upon hydrolysis of the crosslinks; and
(b) uncrosslinking the well treatment agent by hydrolyzing the hydrolysable bonds and then releasing into the well the uncrosslinked well treatment agent, wherein the mesh of the screen is sufficient for the uncrosslinked well treatment agent to flow from the interior of the screen into the well.

13. The method of claim 12, wherein the well treatment agent crosslinked by hydrolyzable bonds is a product of one or more crosslinking agents and a crosslinkable monomer, oligomer, polymer or a mixture thereof and wherein the uncrosslinked well treatment agent introduced into the well is either the one or more crosslinking agents or the crosslinkable monomer, oligomer, polymer or mixture thereof and further wherein the mesh of the screen is sufficient for the uncrosslinked well treatment agent to flow from the interior of the screen into the well.

14. The method of claim 13, wherein the well treatment agent crosslinked by hydrolysable bonds is a component of a shaped compressed pellet and wherein the mesh of the screen is sufficient to restrain flow of the shaped compressed pellet from the interior of the screen into reservoir fluids and further wherein the uncrosslinked well treatment agent separates from the shaped compressed pellet upon uncrosslinking of the well treatment agent.

15. The method of claim 12, wherein the shaped compressed pellet further comprises a binder, weighting agent or a combination thereof.

16. The method of claim 12, wherein the screen assembly is introduced into the well either:
(a) after the subterranean formation has been stimulated;
(b) during shut-in after stimulation of the well; or
(c) after the well has been killed.

17. The method of claim 12, wherein the well treatment agent crosslinked by hydrolysable bonds is selected from the group consisting of scale inhibitors, corrosion inhibitors and mixtures thereof.

18. A method of inhibiting or controlling the formation of scales in a well by:
(a) introducing into the well a shaped compressed pellet having a crosslinked scale inhibitor produced by crosslinking a scale inhibitor having hydrolysable bonds with a crosslinking agent;
(b) flowing the shaped compressed pellet into a targeted area in the well; and
(c) uncrosslinking the crosslinked scale inhibitor by hydrolyzing the hydrolysable bonds and continuously releasing the scale inhibitor from the shaped compressed pellet into the targeted area.

19. The method of claim 18, wherein the shaped compressed pellet further comprises a binder, weighting agent or a combination thereof.

20. The method of claim 18, wherein the scale inhibitor of the crosslinked scale inhibitor is selected from the group consisting of carboxylates, aminocarboxylates, acrylates, carboxylic sulfonated copolymer, sulfates, sulfonates, phosphonates, phosphinos, and oligomers and polymers thereof.

21. The method of claim 20, wherein the crosslinking agent is selected from the group consisting of polyols, polyamines, amino alcohols or polyepoxides or a combination thereof.

22. A method of inhibiting or controlling the formation of corrosion in a well by:
(a) introducing into the well a shaped compressed pellet having a crosslinked corrosion inhibitor having hydrolyzable bonds and produced by crosslinking a crosslinkable monomer, oligomer, polymer or a combination thereof with a crosslinking agent wherein the crosslinking agent is capable of inhibiting or controlling the formation of corrosion in a well;
(b) flowing the shaped compressed pellet into a targeted area in the well; and
(c) uncrosslinking the crosslinked corrosion inhibitor by hydrolyzing the hydrolyzable bonds and continuously releasing the crosslinking agent from the shaped compressed pellet into the targeted area.

23. The method of claim 22, wherein the crosslinking agent is a primary amine, secondary amine, primary alcohol, secondary alcohol, alkyl polyamine, cocoalkylamine, alkoxylated cocoalkylamine, tallow alkylamine or tall oil imidazoline or a mixture thereof.

24. The method of claim 22, wherein the crosslinking agent is tallow propylenediamine, coco propylenediamine, tallow dipropylene triamine, coco dipropylene triamine, N-tallow-1,3-diaminopropane, N-tallow-1,3-tallowdiamine, tallow dipropylene triamine, ethoxylated (3) N-coco-1,3-diamine propane, ethoxylated (12) N-tallow-1,3-diamine propane or ethoxylated (2) cocoalkylamines or a combination thereof.
